(19) United States
(12) Patent Application Publication
(10) Pub. No.: US 2007/0214644 A1
(43) Pub. Date: Sep. 20, 2007

(54) Method for Solid-Phase Bonding of Iron Base Alloy and Aluminum Base Alloy

(76) Inventors: Satoru Kanai, Nagano (JP); Masaru Kobuyashi, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 11/597,392

(22) PCT Filed: Jun. 1, 2004
(86) PCT No.: PCT/JP04/07506

§ 371 Date: Nov. 21, 2006

(51) Int. Cl. B21D 53/28; B21K 1/30; B21K 1/76; B23K 20/00

(52) U.S. Cl. 29/893.37; 228/177; 228/193; 29/893; 29/898

(57) ABSTRACT

[PROBLEMS] To provide a process for producing a lightweight race ring through steady unification, without any deformation, of an aluminum alloy member for constituting a main body of race ring and an iron base alloy member for constituting a raceway surface thereof.
[MEANS FOR SOLVING PROBLEMS] Outer ring (41) of cross roller bearing is a composite part comprised of outer ring main body member (411) of aluminum alloy and, bonded to the inside thereof, outer ring side raceway surface constituting member (412) of iron base alloy. Layer of A7075 type alloy powder (413) is interposed between diffusion bonding face (411a) of outer ring main body member (411) and diffusion bonding face (412a) of outer ring side raceway surface constituting member (412) (step ST3), and diffusion bonding of the members (411, 412) is carried out (step ST4). It has been ascertained that the members (411, 412) can be strongly bonded and unified together by interposing the layer of alloy powder (413) even at bonding temperature lower than in the prior art. Thus, the diffusion bonding can be accomplished without any deformation of the outer ring main body member (411) of aluminum alloy.

### TECHNICAL FIELD

The present invention relates to a method for the solid-phase bonding of an iron-based alloy and an aluminum-based alloy. The method is appropriate for use in the manufacture of lightweight gears wherein the teeth are formed of an iron-based alloy and the other parts are formed of an aluminum alloy, as well as in the manufacture of lightweight bearings wherein the raceway-surface part is formed of iron-based material and the other parts are formed of an aluminum alloy.

### BACKGROUND ART

In order to reduce the weight of gears and bearings, proposals have been made that only the teeth, raceway surfaces, and other such parts that require strength and wear-resistance be formed of an iron-based alloy, and that the other parts be formed of lightweight aluminum alloys. For example, Patent Document 1 proposes a cross roller bearing configured from a raceway-surface part formed of a member made from an aluminum alloy and other parts formed of members made from iron-based materials, which are then bonded together into an integrated whole. Patent Document 2 discloses a lightweight bearing wherein a raceway-ring main body member made from aluminum alloy and a raceway surface member made from an iron-based material are integrated together by diffusion bonding. Further, Patent Document 3 discloses a composite structure in which an internal gear comprises a teeth forming-side ring made from an iron-based material, and a gear main body-side ring made from an aluminum alloy, and in which the rings are integrated together.

[Patent Document 1] JP-A 2000-186718

[Patent Document 2] JP-A 2002-339991

[Patent Document 3] JP-A 2002-307237

### DISCLOSURE OF THE INVENTION

### Problems that the Invention is Intended to Solve

When bearings, gears, and the like are manufactured by bonding iron-based alloy members to aluminum alloy members in this manner, it is possible to obtain lightweight bearings and lightweight gears provided with the required strength.

However, bonding is more difficult with aluminum-based alloys than with other alloys. When employing diffusion bonding, aluminum alloy exposed to high heat at the time of bonding will melt, whereby the dimensional precision of the bonded members tends to decline and other problems tend to occur.

In view of such issues, it is an object of the present invention to provide a method of solid-phase bonding that can tightly bond a member made from an aluminum-based alloy to a member made from an iron-based alloy without inducing deformation.

It is a further object of the present invention to propose a method for manufacturing lightweight gears and lightweight bearing ring races using this method of solid-phase bonding.

### MEANS FOR SOLVING THE ABOVE-MENTIONED PROBLEMS

In order to solve the above-mentioned problems, the method for the solid-phase bonding of an iron-based alloy and an aluminum-based alloy according to the present invention is characterized in comprising the steps of sandwiching a layer of a 7000 series alloy powder (an alloy of Al, Zn, and Mg), preferably a powder of a 7075 alloy containing 5% or more of Zn and 2% or more of Mg, between a bonding face of a first member made from an iron-based alloy and a bonding face of a second member made from an aluminum-based alloy; and diffusion-bonding the first member and the second member in the resulting state.

A value within a range of 30 to 50 μm is preferable for the thickness of the layer of the metal alloy powder.

The method for manufacturing a lightweight gear according to the present invention is characterized in comprising the steps of configuring a gear from a gear main body member made from an aluminum-based alloy, and a teeth-forming member that is made from an iron-based alloy and has teeth formed on an outer or inner periphery; and bonding the gear main body member and the teeth-forming member by the above-mentioned method.

A method for manufacturing a lightweight bearing race according to the present invention is characterized in comprising the steps of configuring the race of the bearing from a race main body member made from an aluminum-based alloy, and a raceway surface-forming member that is made from an iron-based alloy and has a raceway surface formed on an outer or inner periphery; and bonding and integrating the race main body member and the raceway surface-forming member by the above-mentioned method.

### EFFECT OF THE INVENTION

The method of solid-phase bonding according to the present invention confirms that diffusion bonding can be performed at temperatures lower than when performing diffusion bonding by placing the bonding faces of both members together. Accordingly, deformation of the aluminum alloy member at the time of diffusion bonding can be reduced, and bearing raceway rings, gears, and the like that are tightly integrated with minor dimensional error can be manufactured.

### BEST MODE FOR CARRYING OUT THE INVENTION

A wave gear unit in which the present invention is used will be described below with reference to the accompanying drawings.

(Overall Configuration)

FIG. 1 is a cross-sectional view of a wave gear unit provided with a silk hat-form wave gear device incorporating a cross roller bearing, wherein the wave gear device and cross roller bearing are manufactured according to the present invention. FIG. 2 is a descriptive diagram showing the configuration of the silk hat-form wave gear device.

A wave gear unit 1 according to the present example has a first end plate 2 and a second end plate 3 disposed at a fixed gap from each other in the direction of a unit axis line 1a, and a cross roller bearing 4 positioned between the first and second end plates 2, 3. A silk hat-form wave gear device 5 is incorporated within the unit housing, which is composed of the first and second end plates 2, 3 and an outer race 41 of the cross roller bearing 4. In addition, a shaft hole is formed in the center of the first and second end plates 2, 3, through which passes a hollow input shaft 8 that is rotatably supported by ball bearings 6, 7.

The cross roller bearing 4 is composed of the outer race 41, an outer race 42, and a plurality of rollers 43 inserted into the toroidal raceway and defined between the outer and inner races. The outer race 41 is a composite component provided with a toroidal outer-race main body member 411 and a toroidal outer race-side raceway surface-forming member 412 that is formed integrally on the inner periphery of the outer-race main body member 411, and has a raceway surface formed on the inner periphery.

The inner race 42 is a composite component provided with a broad toroidal inner race main body member 421 and a toroidal inner race-side raceway surface-forming member 422 that is formed integrally on the outer periphery part on one edge side of the inner race main body member 421, and has a raceway formed on the outer periphery. Furthermore, the inner race 42 according to the present example comprises a toroidal teeth-forming member 512 that is formed integrally on the inner periphery part on the other edge side of the inner race main body member 421, and has inner teeth 511 formed on the inner periphery. In other words, the inner race 42 according to the present example is a part that is combined with the rigid internally toothed gear of the silk hat-form wave gear device 5 described below. The inner race main body member 421 of the inner race 42 of this configuration is fastened and fixed to the second end plate 3 by a fastening bolt not shown in the drawings.

The silk hat-form wave gear device 5 is composed of a toroidal rigid internally toothed gear 51, a silk hat-form flexible externally toothed gear 52, and an elliptically contoured wave generator 53. The rigid internally toothed gear 51 is formed integrally with the inner race 42 of the cross roller bearing 4 as described above. Only the toroidal teeth-forming member 512, on whose inner periphery the internal teeth 511 are formed, is formed from a separate member and forms an integrated unit on the inner periphery of the inner race 42 that doubles as an internally toothed gear.

The flexible externally toothed gear 52 is composed of a tubular trunk 521, an annular diaphragm 522 that is connected to one end thereof and expands outward in a radial direction, a thick annular boss 523 connected to an outer rim of the diaphragm 522, and external teeth 524 formed on the outer periphery on the other end part of the trunk 521. The complete structure is shaped like a silk hat. The annular boss 523 is sandwiched between the annular end surface of the outer race 41 of the cross roller bearing 4 and the first end plate 2, and is fastened and fixed to these components by a fastening bolt (not shown). Therefore, the flexible externally toothed gear 52 and the rigid internally toothed gear 51 can rotate relative to each other on the cross roller bearing 4.

The wave motion generator 53 is composed of an elliptically contoured rigid cam plate part 531, formed on the outer periphery of the input shaft 8, and a ball bearing 532. The ball bearing 532 is fitted into the space between the outer periphery of the rigid cam plate part 531 and the inner periphery of the section where the external teeth 524 of the flexible externally toothed gear 52 are formed.

An annular plate 9 used as a bolt seat is attached to the annular edge 415 of the outer-race main body member 411 of the outer race 41. A bolt hole 414 is formed in the outer race main body part 411 of the outer race 41. The annular plate 9 is also fastened and fixed to the side of the outer-race main body member 411 by a fastening bolt. A seal ring 91 acting as an oil seal is attached to the inner rim part of the annular plate 9. The gap between the outer race 41 and the inner race 42 is sealed by this seal ring 91.

In the silk hat-form wave gear unit 1 having the above configuration, the protruding part of the rotating input shaft 8 that protrudes from the first end plate 3 is connected and fixed to a motor output shaft or other source of rotation. Further, either the first end plate 2 or the second end plate 3 is connected and fixed to the load side. When the rotating input shaft 8 rotates at high speed, the external teeth 414 are bent into an elliptical shape by the elliptical wave motion generator 53 and are meshed with the internal teeth 424 in two places along the periphery, and the mutually meshed sections of the external teeth move toward the periphery. As the numbers of external teeth and internal teeth are different, relative rotation corresponding to the difference in the number of teeth is generated between the external teeth and the internal teeth. The rotation reduced largely in proportion to the number of input rotations. One of either the first end plate 2 or the second end plate 3 is connected to the load side, and the other is fixed in place so as not to rotate. Therefore, reduced-speed rotation is output from the end plate connected to the load side and transmitted to the load side.

(Materials for Individual Components)

The outer race 41 of the cross roller bearing 4 is a composite component made up of the outer-race main body member 411 and the outer race-side raceway surface-forming member 412. Similarly, the inner race 42 is a composite component made up of the inner race main body member 421, the inner race-side raceway surface-forming member 422, and the teeth-forming member 512 on whose inner periphery are formed the internal teeth 511.

The outer-race main body member 411 and the inner race main body member 421 are formed from an aluminum alloy, which is lighter than an iron-based material. A commonly used iron-based alloy is used for the outer race-side raceway surface-forming member 412 and the inner race-side raceway surface-forming member 422 with which raceway surfaces are formed, as well as the teeth-forming member 512 on which the internal teeth are formed.

In the present example, the input shaft 8 is formed of an aluminum alloy, a titanium alloy or other light metal alloy, a plastic, or a ceramic material or other lightweight material. The rigid cam plate part 531 of the wave generator 53 that is formed on the outer periphery thereof is also formed from the same lightweight material.

(Method of Manufacture of Outer Race and Inner Race)

An example of a method for manufacturing the composite component outer race 41 will now be described with reference to FIG. 3. First, the outer-race main body member 411 is manufactured from an iron-based alloy (SUJ2) (step ST1), and the outer race-side raceway surface-forming member 412 is manufactured from an aluminum-based alloy (A5056) (step ST2). Next, a 40-μm-thick layer of A7075 (Mg 2% or more, Zn 5% or more) fine metal alloy powder 413 is sandwiched between the diffusion bonding face 411a on the inner periphery of the outer-race main body member 411 and the diffusion bonding face 412a on the outer periphery side of the outer race-side raceway surface-forming member 412, in which state the members 411, 412 are coaxially assembled (step ST3). Thereafter, the members 411, 412 are bonded by diffusion bonding (step ST4), resulting in the integrated outer race 41. Bonding in a diffusion bonding process was confirmed to be achievable within a temperature range of 500 to 600° C.

The inner race 42 may be manufactured in a similar manner. In the inner race 42 according to the present example, the teeth-forming member 512 is also integrated into the inner race 42 by diffusion bonding.

### Other Embodiments

In the example described above, the present invention is used in a race of a cross roller bearing, but it shall be apparent that the present invention may be similarly used to make other forms of races for ball bearings and other bearings. The present invention may also similarly be used for general externally toothed gears and internally toothed gears.

### BRIEF DESCRIPTION OF THE DRAWINGS

FIG. 1 is a schematic cross-sectional view of a silk hat-form wave gear unit as applied to the present invention;

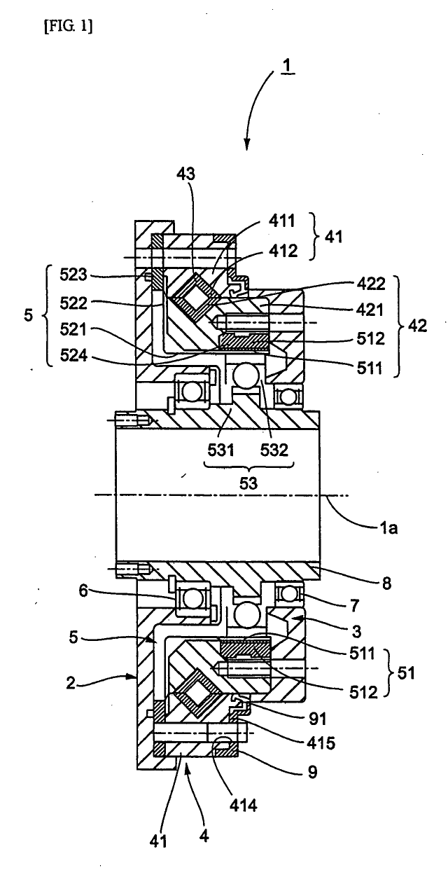

FIG. 2 is a descriptive diagram showing the configuration of the wave gear device of FIG. 1; and

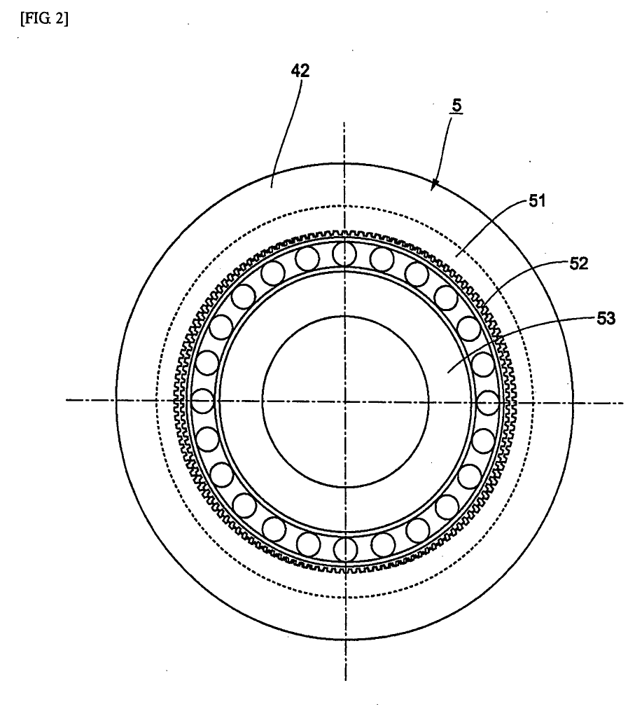

FIG. 3 is a descriptive diagram showing a step for manufacturing an outer race.

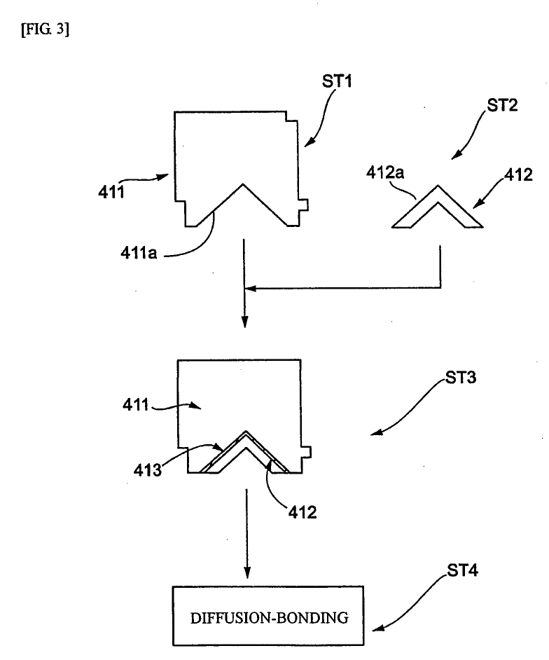

### SYMBOLS

1 Wave gear unit
2, 3 End plate
4 Cross roller bearing
41, 151 Outer race
411 Outer-race main body member
411a Diffusion bonding face
412 Outer race-side raceway surface-forming member
412a Diffusion bonding face
413 Fine metal alloy powder layer
42 Inner race
421 Inner race main body member
422 Inner race-side raceway surface-forming member
43 Roller
5 Wave gear device
51 Rigid internally toothed gear
511 Internal teeth
512 Teeth-forming member
52 Flexible externally toothed gear

1. A method for the solid-phase bonding of an iron-based alloy and an aluminum-based alloy, comprising the steps of:
sandwiching a layer of a 7000 series alloy powder (an alloy of Al, Zn, Mg and Cu) between a bonding face of a first member made from an iron-based alloy and a bonding face of a second member made from an aluminum-based alloy; and
diffusion-bonding the first member and the second member in the resulting state.

2. The method for the solid-phase bonding of an iron-based alloy and an aluminum-based alloy according to claim 1, characterized in that:
the alloy powder is a powder of a 7075 alloy containing 5% or more of Zn and 2% or more of Mg.

3. The method for the solid-phase bonding of an iron-based alloy and an aluminum-based alloy according to claim 1, characterized in that:
the thickness of the alloy powder layer is a dimension within a range of 30 to 50 μm.

4. A method for manufacturing a lightweight gear characterized in comprising the steps of:
configuring a gear from a gear main body member made from an aluminum-based alloy, and a teeth-forming member that is made from an iron-based alloy and has teeth formed on an outer or inner periphery; and
bonding and integrating the gear main body member and the teeth-forming member by the method according to claim 1.

5. A method for manufacturing a lightweight bearing race characterized in comprising the steps of:
configuring the race of the bearing from a race main body member made from an aluminum-based alloy, and a raceway surface-forming member that is made from an iron-based alloy and has a raceway surface formed on an outer or inner periphery; and
bonding and integrating the race main body member and the raceway surface-forming member by the method according to claim 1.
